(19) United States
(12) Patent Application Publication
(10) Pub. No.: US 2025/0343960 A1
(43) Pub. Date: Nov. 6, 2025

(54) ASSISTING VIEWER ENGAGEMENT ON SHORT-FORM VIDEO SERVICES USING ARTIFICIAL INTELLIGENCE

(71) Applicant: Sud Scrub Inc., Las Vegas, NV (US)

(72) Inventors: Benjamin T. Paley, Pinehurst, NC (US); Michael J. Fox, Portland, OR (US); Michael J. Paley, Pinehurst, NC (US)

(73) Assignee: Sud Scrub Inc., Las Vegas, NV (US)

(21) Appl. No.: 19/194,404

(22) Filed: Apr. 30, 2025

Related U.S. Application Data
(60) Provisional application No. 63/641,198, filed on May 1, 2024.

(51) Int. Cl. H04N 21/2743; H04N 21/431; H04N 21/45; H04N 21/4788; H04N 21/84

(52) U.S. Cl. CPC H04N 21/2743; H04N 21/4312; H04N 21/4532; H04N 21/4788; H04N 21/84

(57) ABSTRACT

A system for enhancing viewer engagement causes display of a short-form video hosted on the short-form video hosting service on a first portion of a user interface. The system can receive an input including a comment in response to the short-form video. The comment input can include a first text string. The system can cause display of the comment received from the particular viewer on a second portion of the user interface. The system can cause a generative artificial intelligence (AI) system to automatically create a response to the comment based on the first text string and metadata associated with the short-form video. The response can include a second text string. In response to approval from the content provider to publish the response, the system can cause display of the response proximate to the comment on the second portion of the user interface.

### CROSS-REFERENCE TO RELATED APPLICATION(S)

This application claims priority to U.S. Application No. 63/641,198 filed May 1, 2024, the entire contents of which are incorporated herein by reference.

### BACKGROUND

Publishing and sharing video content, and in particular short-form videos, on the internet has become a popular part of social media. Platforms for sharing such video content, including software applications and websites, are popular sources of entertainment and marketing, as well as distributing information. Users commonly subscribe to a video content platform by establishing an account. Users can operate as content providers, content viewers, or both. An important part of the video content platform is that both content providers and content viewers engage with the platform by interacting with the platform and/or other users. The engagement can be done by providing likes and comments. The more comments and likes a video on a video content platform receives, the more popular the video is. The popularity affects the visibility that the video can achieve on the platform. Therefore, effective methods for enhancing viewer engagement on a video content platform are important for content providers.

### BRIEF DESCRIPTION OF THE DRAWINGS

Reference will now be made, by way of example, to the accompanying drawings, which show example implementations of the present application and in which:

FIG. 1 is a block diagram illustrating an exemplary server system environment, which can be used to implement examples of the present disclosure.

FIGS. 2 through 5 illustrate user interfaces associated with providing viewer engagement assistance on short-form video services.

FIG. 6 is a flowchart that illustrates processes for providing assisted view engagement on short-form video services.

FIG. 7 is a block diagram that illustrates an example of a computer system in which at least some operations described herein can be implemented.

FIG. 8 is a block diagram of a transformer neural network, which may be used in examples of the present disclosure.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for systems and methods for assisting content providers to engage their viewers on content sharing platforms (e.g., social media platforms, social networking platforms, multimedia platforms, and virtual platforms) by generative artificial intelligence (AI). Viewer engagement is an important parameter on content sharing platforms as it significantly affects the prioritization that a shared content receives among other shared content. For example, the more views and comments that a video clip receives, the more visibility the video clip receives on the content sharing platform. Popularity of a shared content can be measured, for example, by a number of views and comments the content receives. High viewer engagement is especially important for content providers who use the content sharing platforms to monetize their content. Viewer engagement can be enhanced by the content provider by providing responses to viewer comments. The responses can help the content provider build a community and further provide entertaining or informative interaction with the viewers.

The present technology is directed to provide AI generated responses to user comments that are generated based on the user comments as well as information associated with the content itself. In particular, the present technology provides AI generated responses that are accurate and prompt and, in addition, reflect the style, tone, and content associated with the content provider. Specifically, in instances where the shared content includes video content (e.g., short-form videos), the AI generated response is created based on a comment as well as information associated with the video content. The information can include, for example, a description of the video content.

In one example, a system for enhancing viewer engagement causes display of a short-form video hosted on the short-form video hosting service on a first portion of a user interface. The short-form video can be uploaded to the short-form video hosting service by a content provider having a content provider subscription to the short-form video hosting service. The short-form video can be viewable on the short-form video hosting service by multiple viewers who each have a viewer subscription to the short-form video hosting service. The system can receive an input by a particular viewer of the multiple viewers. The input can include a comment in response to the short-form video. The comment input can include a first text string. The system can cause display of the comment received from the particular viewer on a second portion of the user interface. The comment can be configured for display on the second portion of the user interface in association with the short-form video. The comment can be viewable by the multiple viewers. The system can cause a generative AI system to automatically create a response to the comment based on the first text string and metadata associated with the short-form video. The response created by the generative AI system can include a second text string different from the first text string. In response to approval from the content provider to publish the response created by the generative AI system, the system can cause display of the response proximate to the comment on the second portion of the user interface.

In another example, a system causes display of a short-form video hosted on the short-form video hosting service on a first portion of a user interface. The short-form video can be uploaded to the short-form video hosting service by a content provider. The short-form video can be viewable on the short-form video hosting service by multiple viewers. The system can receive an input including a comment in response to the short-form video. The input can be by a particular viewer of the multiple viewers. The comment input can include a first text string. The system can cause display of the comment received from the particular viewer on a second portion of the user interface. The system can cause a generative AI system to automatically create a response to the comment based on the first text string and metadata associated with the short-form video. The response created by the generative AI system can include a second text string different from the first text string. In response to approval from the content provider to publish the response created by the generative AI system, the system can cause display of the response proximate to the comment on the second portion of the user interface.

In yet another example, a method for enhancing viewer engagement includes causing display of a short-form video hosted on the short-form video hosting service on a first portion of a user interface. The short-form video can be uploaded to the short-form video hosting service by a content provider. The short-form video can be viewable on the short-form video hosting service by multiple viewers. The system can receive an input including a comment in response to the short-form video. The input can be by a particular viewer of the multiple viewers. The comment input can include a first text string. The system can cause display of the comment received from the particular viewer on a second portion of the user interface. The method can include causing a generative AI system to automatically create a response to the comment based on the first text string and metadata associated with the short-form video. The response created by the generative AI system can include a second text string different from the first text string. In response to approval from the content provider to publish the response created by the generative AI system, the method can include causing display of the response proximate to the comment on the second portion of the user interface. The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Viewer Engagement

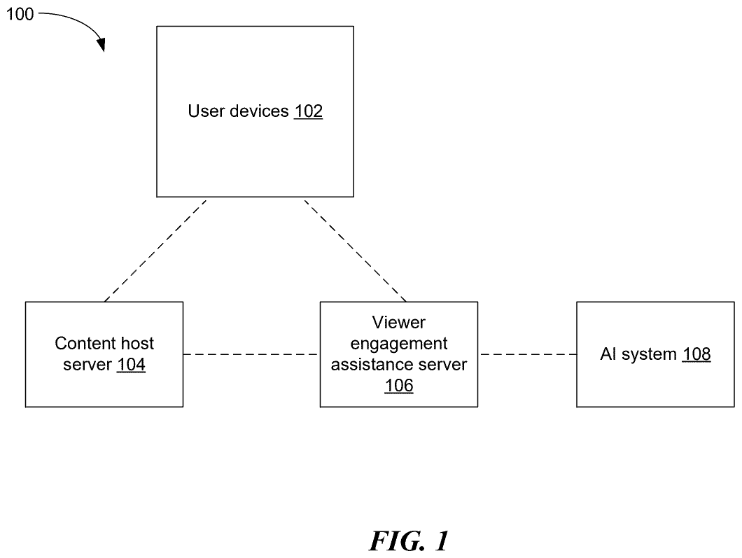

FIG. 1 is a block diagram illustrating an exemplary environment 100 (e.g., an environment of servers, server systems, and/or devices), which may be used to implement examples of the present disclosure. The environment 100 includes user devices 102, a content host server 104, a viewer engagement assistance server 106, and an AI system 108. The user devices 102, the content host server 104, the viewer engagement assistance server 106, and the AI system 108 can be configured to be in wireless communication within the environment. For example, the user devices 102 are in wireless communication with the content host server 104 and/or the viewer engagement assistance server 106. The viewer engagement assistance server 106 can be in communication with the content host server 104 and/or the AI system 108. The environment 100 is understood to be exemplary, and the different functions of the different servers and devices of the environment described herein can be performed by alternative servers or devices. For example, the functions of the content host server 104 and the viewer engagement assistance server 106 can be performed by separate systems, a single system, or sub-systems of a single system. The terms server and server system can be used interchangeably in this disclosure.

The user devices 102 can include personal computers, laptop computers, tablet computers, mobile phones, augmented reality/virtual reality (AR/VR) devices, and/or any other user devices configured for accessing content via the internet. The user devices 102 can be used for communication with host platforms on websites or through software applications operating on the user devices 102. Specifically, the user devices 102 can be configured to access the content host server 104 via a software application or a website.

The content host server 104 can be associated with platforms including content sharing platforms such as social media platforms, social networking platforms, multimedia platforms, virtual platforms, etc. In some implementations, the content host server 104 is associated with a platform for creating, publishing, and distributing video content, image content, text content, audio content, or any combination thereof. The video content can include short-form videos (e.g., video clips). For example, the content host server 104 can be configured to allow users (e.g., via the user devices 102) to create short videos or audio tracks (e.g., video or audio clips having a duration of up to one minute, two minutes, or five minutes). The content host server 104 can provide tools for editing the videos or audio tracks and allows users to publish the created videos or audio tracks on the associated platform. The user devices 102 can be associated with content providers as well as content consumers (e.g., viewers) for the platform of content host server 104. Generally, content providers and consumers have subscriptions to the platform associated with the content host server 104.

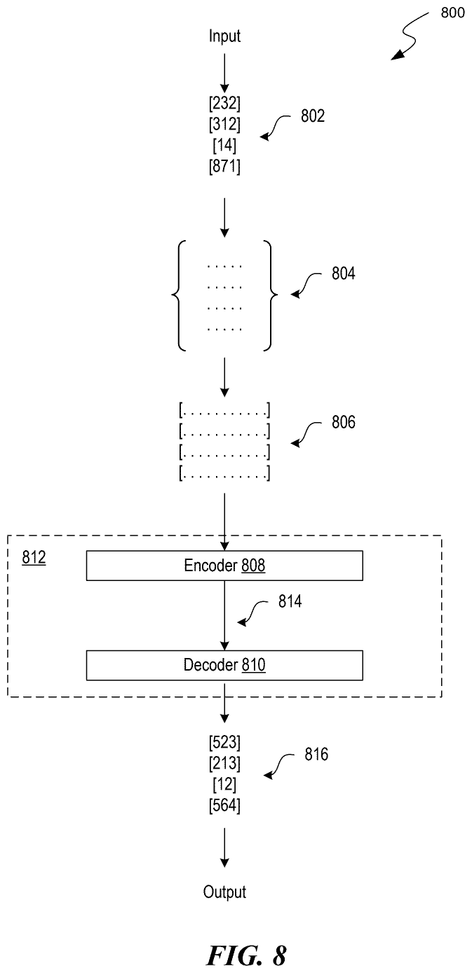

The viewer engagement assistance server 106 can receive input from and/or provide input to the user devices 102 and/or the content host server 104. The viewer engagement assistance server 106 can also provide input and receive output from the AI system 108. The AI system 108 can be a generative AI system including a machine learning (ML) model, such as a large language model (LLM). The operations of an AI system are described in the Transformer for Neural Network section including the description of FIG. 8. The viewer engagement assistance server 106 is configured to assist content providers who provide content on the content host server 104 to engage their viewers (e.g., viewers associated with user devices 102). The engagement can include causing the AI system 108 to create responses to viewers' comments. As an example, a content provider publishes a video clip on the platform associated with the content host server 104. The video clip can be viewed by multiple viewers who also provide likes and comments related to the video clip. The viewer engagement assistance server 106 can assist the content provider in responding to the comments by the multiple viewers by causing the AI system 108 to generate responses to the comments from the multiple reviewers. Specifically, the viewer engagement assistance server 106 can cause the AI system 108 to generate responses with a style, substance, and/or tone that is preferred by the content provider.

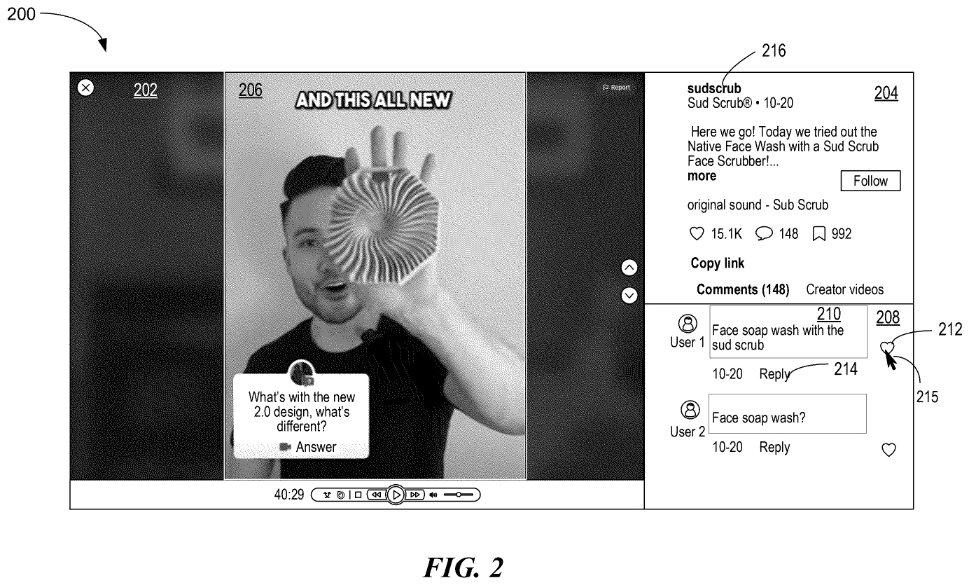

FIGS. 2 through 5 illustrate user interfaces for providing assisted viewer engagement on short-form video services. FIG. 2 illustrates a user interface 200 associated with a short-form video platform (e.g., a social media platform allowing publishing of short-form videos). The user interface 200 can be a user interface displayed on a website or on a software application associated with a content host server (e.g., the content host server 104 described with respect to FIG. 1). For example, the user interface 200 can be displayed on the user devices 102 in FIG. 1.

The user interface 200 includes video display portion 202 displaying a video 206. The user interface 200 also includes an interactive portion 204 for allowing a content provider and viewers of the video to interact with each other. The video 206 can be provided by a content provider (e.g., content provider 216 “sudscrub”). For example, the content provider 216 has subscribed to a service provided by the content host server 104 and can, therefore, generate, publish, and distribute content via the platform associated with the content host server 104. The video 206 can be viewed by other subscribers for the platform (e.g., “User 1” and “User 2”).

The interactive portion 204 can further include a comments portion 208 that allows the other users to interact with the content provider 216 by providing comments and feedback related to the video. The subscribers can, for example, interact with the user interface 200 by providing inputs (e.g., an input via a cursor or a caret) on various control items of the user interface 200. A control item refers to a visual element on a graphical user interface that is associated with a particular action or interaction performed in response to receiving an input on the control item. In some implementations, a control item is selectable so that a user can provide an input (e.g., a click input) to select to perform the action associated with the control item. In some implementations, a control item includes a text field that allows a user to input text inside the control item. As an example, the (heart-shaped) control item 212 allows a subscriber to indicate that they like the video. For example, a user provides an input (e.g., a click) when a cursor 215 is positioned on the control item 212. The number of likes can be indicated on the interactive portion 204 (e.g., the heart-shaped icon associated with a number 15.1K indicates that the video has been liked by 1515.1K subscribers. As another example, the subscribers can provide comments on the comments portion 208. For example, the subscriber “User 1” has provided an input on a text field to enter a comment 210 (e.g., the text string “Face soap wash with the sud scrub”). The comments portion 208 also includes a reply control item 214 that allows subscribers or the content provider 216 to reply to the comment 210. For example, in response to a click input, the reply control item 214 activates a text input control item that allows the user to insert input (e.g., text, images, videos, symbols, icons) on the text input control item.

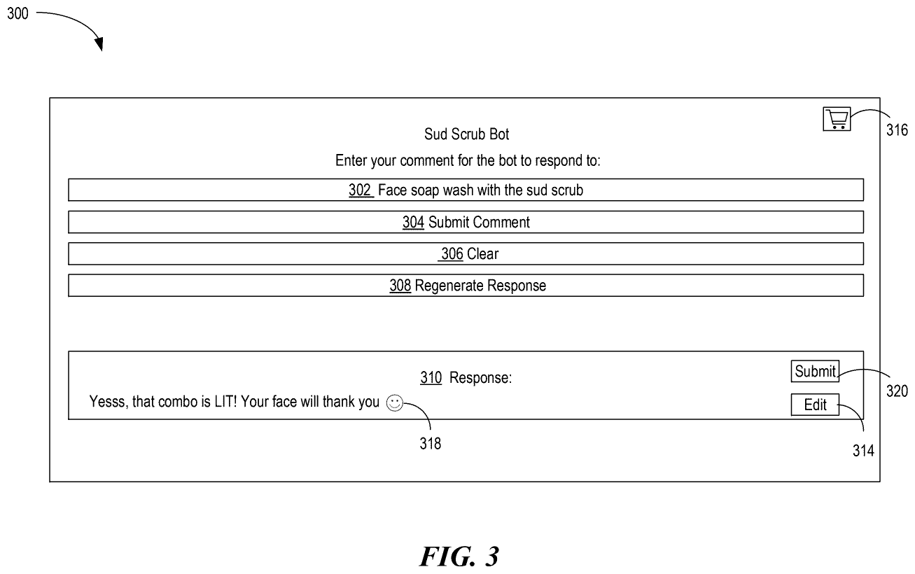

FIG. 3 illustrates a user interface 300 for generating automated responses to comments on the user interface 200. The user interface 300 can be associated with a viewer engagement assistance server (e.g., the viewer engagement assistance server 106 described with respect to FIG. 1). The user interface 300 includes control items, such as a comment input control item 302, a comment submission control item 304, a clearing control item 306, a response regeneration control item 308, a cart control item 316, a submission control item 320, and an editing control item 314. The user interface 300 also includes a user interface element for displaying a generated response (e.g., a response interface element 310).

The comment input control item 302 (a text field control item) allows a user to input a text string corresponding to a subscriber comment that they want to generate a response to. For example, the text string can be added to the comment input control item 302 by copying the text string from the comment 210 in FIG. 2 and pasting the text string to the comment input control item 302 in FIG. 3. Alternatively, the server associated with the user interface 300 can be configured to extract comments from comments portion 208 in FIG. 2 automatically to populate the comment input control item 302. The comment submission control item 304 can be configured to transmit the text string on the comment input control item 302 to an AI system (e.g., the AI system 108 in FIG. 1) for processing. For example, the viewer engagement assistance server 106 transmits the text string from the comment input control item 302 together with other information associated with the video (e.g., the video metadata) and/or information associated with the content provider 216 and/or the subscriber (e.g., User 1) who provided the comment 210. The AI system 108 can be configured to generate a response to the transmitted text string and transmit the response back to the viewer engagement assistance server 106. The response can be displayed in the response interface element 310 (“Yess, that combo is LIT! Your face will thank you”). The response generated by the AI system 108 can also include image objects such as symbols or icons (e.g., a graphical object 318). The response generated by the AI system 108 can be configured to mimic the style, substance, or tone that the content provider 216 customarily uses in their communication.

The editing control item 314 can allow a user to modify the text string on the response interface element 310. For example, in response to a user input on the editing control item 314, the response interface element 310 can be activated so that a user can provide a further input to modify the text string. The clearing control item 306 allows a user to clear (e.g., delete) content from the comment input control item 302. The response regeneration control item 308 allows a user to regenerate the response. For example, the viewer engagement assistance server 106 repeats transmitting the text string from the comment input control item 302 together with other information associated with the video and/or information associated with the content provider 216 and/or the subscriber who provided the comment 210 to the AI system 108. The AI system 108 can be configured to regenerate the response to the transmitted text string and retransmit the response back to the viewer engagement assistance server 106. The regenerated response can be different from the initially generated response.

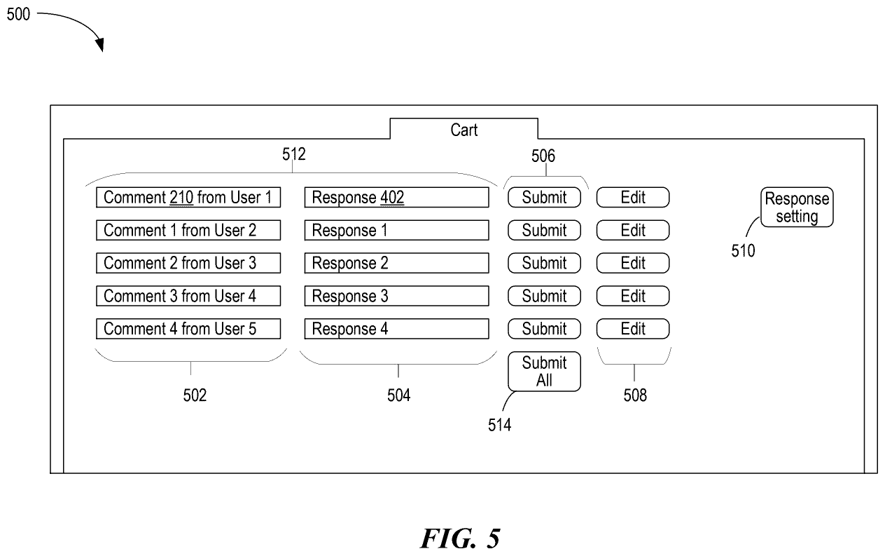

In some implementations, the responses received from the AI system 108 can further require an approval from a user prior to being displayed on the user interface 200 in FIG. 2. The approval can include receiving an input on the submission control item 320 that operates as an indication that the response in the response interface element 310 is approved to be published on the user interface 200. Alternatively, the generated responses can be added to a cart (e.g., a virtual cart) that is displayed on a separate user interface page (e.g., an approval user interface 500 described with respect to FIG. 5). A cart can refer to a virtual container including one or more responses that are waiting for approval prior to being published. The approval user interface can allow the user to review and accept one or more responses on the single user interface. The cart control item 316 in FIG. 3 can allow the user to access such approval user interface. For example, concurrently with displaying the response generated by the AI system 108 in the response interface element 310, the response can be added to the cart.

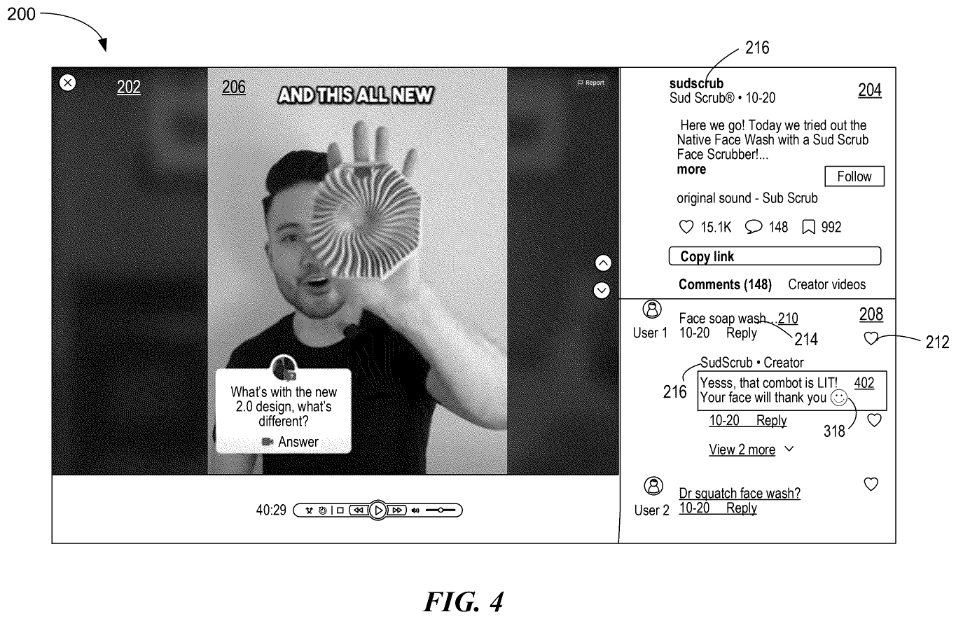

FIG. 4 illustrates the user interface 200, which is now updated with the response generated by the AI system 108. As shown, a response 402 is displayed below the comment 210 in the comments portion 208 of the user interface 200. The response 402 includes the same text string as was shown in the response interface element 310 (“Yess, that combo is LIT! Your face will thank you”) as well as the graphical object 318. The response 402 is positioned adjacent to the comment 210 and is indented with respect to the comment 210 to illustrate that the response 402 is associated with the comment 210. In some implementations, the user can add the response 402 to the comments portion 208 by activating a text input control item by an input on the reply control item 214. In some embodiments, the viewer engagement assistance server 106 can be configured to populate the response 402 on the comments portion 208 automatically after the response has been generated and approved.

FIG. 5 illustrates the approval user interface 500, which can be displayed in response to an input on the cart control item 316. The approval user interface 500 allows a user to review and approve multiple responses conveniently from a single user interface. For example, instead of approving single responses (e.g., by an input on the submission control item 320 in FIG. 3) or inserting the response 402 in FIG. 4 by typing or copying and pasting the string of text, a user can review and approve the string of text on the approval user interface 500. The approved response can then be automatically populated to the comments portion 208 as the response 402 in FIG. 4.

The approval user interface 500 includes a list of response items 512. The list to response items 512 includes multiple comments 502 and corresponding responses 504 that are waiting for a user's approval. For example, the comments 502 include the comment 210, and the responses 504 include the response 402. The approval user interface 500 also includes submission control items 506 that allow a user to submit each of the responses to be published on the comments portion 208 in FIG. 4. Submission can be done by an input (e.g., a click input) on a respective submission control item. An input on a submission control item 514 (“Submit All”) allows a user to submit all the responses in the list of response items 512 with a single input. The approval user interface 500 also includes edit control items 508 that allow the user to modify the respective responses. For example, an input on an edit control item associated with the response 402 activates an input control item that allows the user to add, remove, and/or change the text of the response 402. The approval user interface 500 also includes a response setting control item 510. The response setting control item 510 can allow a user to open a settings user interface (e.g., a pop-up window or a tab associated with the approval user interface 500) that includes settings associated with the generated responses. The settings user interface can allow the user to view and modify any settings, parameters, preferences, etc. associated with the response generation. The settings can include, for example, a length of responses, a style of responses, use of image objects (e.g., icons and symbols such as emojis), content type (e.g., text, audio, video), information used in generating the responses, and any other settings, parameters, preferences, etc. associated with the response generation.

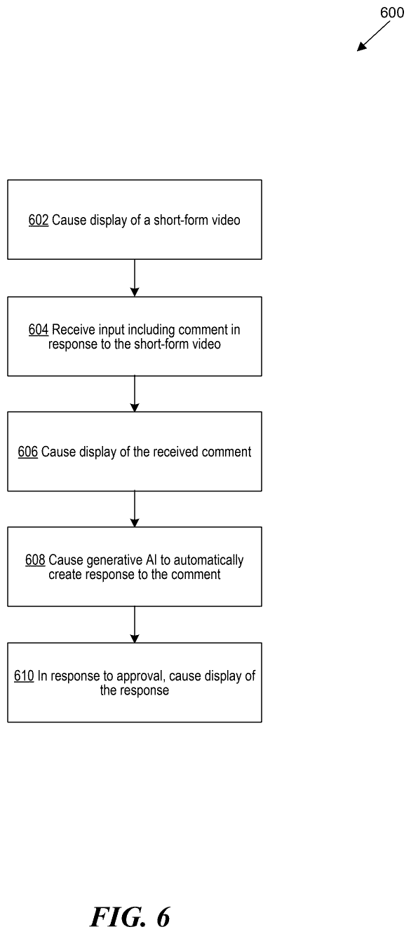

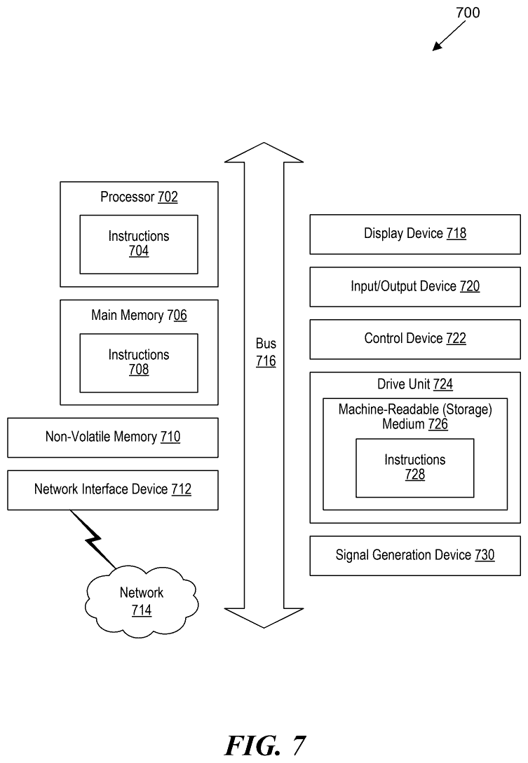

FIG. 6 is a flowchart that illustrates processes 600 for providing assisted viewer engagement on short-form video services. The processes 600 can be performed in an environment including server systems and devices (e.g., the environment 100 in FIG. 1). The environment can include one or more servers including at least one hardware processor and at least one non-transitory memory storing instructions (e.g., the computer system 700 described with respect to FIG. 7). When the instructions are executed by the at least one hardware processor, the one or more servers perform the processes 600. In some implementations, the processes 600 are performed by a viewer engagement assistance server system (e.g., the viewer engagement assistance server 106 described with respect to FIG. 1).

The processes 600 can be directed to provide AI generated responses to user comments on content shared on content sharing platforms. A response is generated in response to a comment received from a viewer of the shared content. The response is generated to reflect the content itself as well as to represent the style and tone defined by the content provider.

At 602, the server system for enhancing viewer engagement causes display of a short-form video hosted on the short-form video hosting service on a first portion of a user interface—for example, the video 206 on the video display portion 202 of the user interface 200 in FIG. 2. The user interface 200 can be associated with the content host server 104. The content host server 104 is a host or a provider for a content sharing platform.

The short-form video can be uploaded to the short-form video hosting service by a content provider (e.g., a content provider associated with a user device of the user devices 102 in FIG. 1) having a content provider subscription to the short-form video hosting service. For example, the video 206 in FIG. 2 is provided by the content provider 216. The short-form video can be viewable on the short-form video hosting service by multiple viewers (e.g., “User 1” and “User 2” in FIG. 2 who are viewing the content by user devices 102 described with respect to FIG. 1) who each have a viewer subscription to the short-form video hosting service. A viewer and/or content provider subscription can include, for example, having a unique username and a unique user profile registered with the content host server 104. Generally, parties or individuals can be content providers and content viewers concurrently via their subscriptions.

In some implementations, the short-form video is created by a user associated with the short-form video hosting service. The user can be different from the content provider. A subscriber of the short-form video hosting service can generate a video that is associated with a topic or a theme that is in the interest of the content provider. For example, the subscriber generates a video that is provided by a commercial product associated with the content provider who is a seller or a manufacturer of the commercial product. The content provider can publish the video generated by the subscriber on their account on the content sharing website. The content provider can also generate and create their own videos and publish and share them on their account.

At 604, the server system can receive an input by a particular viewer of the multiple viewers. For example, the subscriber can add a comment on the comments portion 208 of the user interface 200 in FIG. 2 by activating a text input control item. The subscriber can write a text on the text input control item and provide an additional input for publishing the comment. The input can include a comment in response to the short-form video (e.g., the comment 210 by “User 1” in FIG. 2). The comment input can include a first text string (e.g., the text string “Face soap wash with the sub scrub”).

At 606, the server system can cause display of the comment received from the particular viewer on a second portion of the user interface. The comment can be configured for display on the second portion of the user interface in association with the short-form video (e.g., the comment 210 by “User 1” in the comments portion 208 of FIG. 2). The comment can be viewable by the multiple viewers.

At 608, the server system can cause a generative AI system (e.g., AI system 108 such as an LLM system) to automatically create a response to the comment based on the first text string and metadata associated with the short-form video. The response created by the generative AI system can include a second text string different from the first text string. For example, in response to an input on the comment submission control item 304 in FIG. 3, the server system transmits the first text string (e.g., the text string of comment 210 in FIG. 2, also included in the comment input control item 302 in FIG. 3) to the generative AI system. The AI system can create a response (e.g., the text string in the response interface element 310 in FIG. 3, also displayed as the response 402 in FIG. 4) to the comment and transmits the response to the server system.

The AI system can include a model that is pre-trained to create responses to comments based on the text strings in the comments. For example, the response created by the AI system can be based on a pre-trained LLM algorithm. The model can include a pre-trained transformer described with respect to FIG. 8. The model can take the first text string as an input and produce the second text string as an output. The model can also be trained to create the responses to comments based on metadata. Metadata associated with the short-form video can include a title, one or more keywords, one or more tags or hashtags, information regarding the creator of the short-form video, information regarding the content provider publishing the short-form video, a date and time of publishing and/or uploading the short-form video, information of geographical location where the short-form video was created, engagement parameters (e.g., number of views, number of likes, number of comments, number of shares), a duration, a representative icon or symbol, privacy settings, copyrights information, and/or related content (e.g., other content linked with the short-form video).

In some implementations, the metadata can include a description of the short-form video and the model can also be trained to create the responses to comments based on the description. In some implementations, the server system can generate a description of the short-form video. The description can be saved in the metadata. The description can be generated by processing the short-form video to extract closed captioning from audio associated with the video or to generate a transcription of the short-form video using natural language processing (NLP).

In some implementations, the server system is caused to receive a description of the short-form video from the content provider. For example, a subscriber generated the short-form video on their user device and also generated a description of the short-form video, which is then included in the metadata of the short-form video. The server system can store the description of the short-form video in the metadata associated with the short-form video.

In some implementations, the generative AI system is trained to create the response so that the response that mimics a style, substance, and/or tone of the content provider. The style can define, for example, whether the response is professional, humorous, conversational, entertaining, or informative. The tone can be used to reflect, for example, emotions such as excitement, happiness, or concern. The substance of the response can be defined as, for example, promotional content, educational content, news content, or personal or inspirational stories or quotes.

In some implementations, the generative AI system can be trained to mimic the style, substance, and/or tone of a person on the video. For example, if a main character of the short-form video is providing promotional information in a humorous style with an exciting tone, the generative AI system can be configured to generate the response to mimic the main character's output. The training can be done, for example, based on transcription of the main character's speech in the video. In another implementation, the generative AI system can be trained based on the style, substance, and/or tone of the whole short-form video. The training can be done in such instances based on transcription of the whole video.

In some implementations, the second text string of the response is configured in accordance with a style, substance, and/or tone that is predefined or selected by an administrator. The administrator can be, for example, the content provider (e.g., the content provider 216 in FIG. 2), the content creator, or an administrator associated with the viewer engagement assistance server (e.g., the viewer engagement assistance server 106 in FIG. 1) or the content host server (e.g., the content host server 104 in FIG. 1). For example, the administrator can create a training set for training the generative AI system to create responses with the style, substance, and/or tone defined by the administrator. The administrator can also add keywords, categorization (e.g., by tags or hashtags), or description to the metadata associated with the short-form video to define the style, substance, and/or tone.

In some implementations, the short-form video further includes audio content. The response can be further created by the generative AI system based on the input including the audio content of the short-form video. For example, the audio content can include speech or a song. The speech and/or the lyrics of the song can be extracted (e.g., by NLP) from the short-form video and used as an input for the generative AI system. The generative AI system can be trained to generate responses based on speech and/or songs.

In some implementations, the comment can include, in addition to the first text string, one or more graphical objects. The one or more graphical objects can be image objects, symbols, and/or icons. The one or more graphical objects can be configured for use in electronic communication to express an emotion, a reaction, and/or a concept. In some implementations, causing the generative AI system to automatically create the response to the comment includes causing the server system to create the response based on the one or more graphical objects included in the comment. The response is created based on the one or more graphical objects in addition to the first text string. The one or more graphical objects can be configured to express an emotion, a reaction, and/or a concept in an electronic communication. The generative AI system can be trained to generate responses based on a combination of text string and one or more graphical objects. Also, the response created by the generative AI system can include the second text string and one or more graphical objects.

For example, a graphical object is an emoji (e.g., a digital image used to express an idea, emotion, or concept) (e.g., the graphical object 318 is an emoji expressing a smiley face in FIG. 3). As another example, a graphical object is a GIF (Graphics Interchange Format) including animated and/or static images (e.g., displayed in a continuous loop). The response generated by the generative AI system can likewise include, in addition to the second text string, one or more graphical objects (e.g., the graphical object 318 in FIG. 3).

In some implementations, causing the generative AI system to automatically create the response to the comment includes causing the server system to create the response based on input including multiple comments associated with the short-form video received from one or more viewers of the multiple viewers. The multiple comments can be weighted less than the comment in creation of the response by the generative AI system. For example, the response 402 from “User 1” in the list of response items 512 in FIG. 5 can be created based on comment 210 as well as any other comments (e.g., comments 1 through 4 by different users) associated with the same short-form video. However, a greater weight is given to the comment 210 that the response 402 is directly supposed to respond to.

In some implementations, the response is further created by the generative AI system based on input including a viewer profile associated with the particular viewer that provided the comment. For example, the response 402 in FIG. 4 can be created partly based on the user profile of “User 1” who provided the comment 210. The profile can include information on the viewer's geographical location, a username, biographical information (e.g., a biographical description that the viewer has provided), and information about the viewer's activities on the content sharing platform (e.g., videos liked, shared, created). The response can thereby include content and style that are customized for the user that provided the comment.

At 610, in response to approval from the content provider to publish the response created by the generative AI system, the server system can cause display of the response proximate to the comment on the second portion of the user interface. The approval can be by the content provider, the content creator, an administrator associated with the viewer engagement assistance server, or the content host server. The approval can also be provided by any user authorized to approve the comments. The approval can be done on the approval user interface 500 (e.g., by an input on a respective submission control item of the submission control item 506 or on the submission control item 514). Alternatively, the approval can be done by inserting the response 402 in FIG. 4 from the response interface element 310 in FIG. 3 by typing or copying and pasting the string of text. In response to the approval, the comment can be displayed on the comments portion 208 in FIG. 4 (e.g., the response 402 is displayed adjacent to the comment 210 in FIG. 4).

In some implementations, the server system is further caused to cause display of the response (e.g., the response including the second string of text in the response interface element 310 in FIG. 3) created by the AI system prior to receiving the approval from the content provider to publish the response. The response is displayed on an additional user interface (e.g., the user interface 300 in FIG. 3). The additional user interface can be accessible by the content provider. The server system can cause display of an approval control item (e.g., the submission control items 506 or the submission control item 514) for receiving an input for the approval to publish the response on the additional user interface.

In some implementations, the server system can receive an input from the content provider to modify the response created by the generative AI system. For example, the editing control item 314 can allow a user to modify the text string on the response interface element 310. In response to a user input on the editing control item 314, the response interface element 310 can be activated so that a user can provide a further input to modify the text string. The server system can receive an approval from the content provider to publish the modified response (e.g., an input on the submission control items 506 or the submission control item 514). The response that is published to the comment on the second portion of the user interface can correspond to the modified response. In some implementations, the server system can cause the AI system to further train the model (e.g., the LLM algorithm) based on the input to modify the response. In some implementations, the server system can cause display of an approval control item for receiving an input for the approval to publish all the respective responses on the additional user interface (e.g., the submission control item 514 in FIG. 5).

In some implementations, the server system is further caused to receive additional inputs corresponding to multiple comments associated with the short-form video. The server system can cause display of the multiple comments on the second portion of the user interface. For example, the comments portion 208 includes comments from “User 1” and “User 2.” The server system can cause the AI system to create respective responses to the multiple comments (e.g., comments 502 and respective responses 504 in FIG. 5). In response to receiving approvals (e.g., from the content provider) to publish the respective responses created by the AI system, the server system can cause display of the respective responses adjacent to the multiple comments on the second portion of the user interface. In some implementations, the respective responses are published by causing display sequentially at a particular frequency on the second portion of the user interface. For example, the respective responses are published with a frequency of every 10 seconds, every 20 seconds, every 30 seconds, or every minute. In some implementations, the respective responses include text and/or one or more images, wherein the respective responses are different from each other.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computer system 700 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 700. In some implementations, the computer system 700 can be an embedded computer system, a system-on-chip (SOC), a single-board computer (SBC) system, or a distributed system such as a mesh of computer systems, or it include one or more cloud components in one or more networks. Where appropriate, one or more computer systems 700 can perform operations in real time, near real time, or in batch mode.

The network interface device 712 enables the computer system 700 to mediate data in a network 714 with an entity that is external to the computer system 700 through any communication protocol supported by the computer system 700 and the external entity. Examples of the network interface device 712 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computer system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computer system 700 to perform operations to execute elements involving the various aspects of the disclosure.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”), and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks, and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions), for example, as compared with models with fewer layers. In the present disclosure, the term “ML-based model” or, more simply, “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online web pages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder) or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger dataset. For example, a dataset may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger dataset and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed, and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture) unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 8 is a block diagram 800 of an example transformer 812. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 812 includes an encoder 808 (which can include one or more encoder layers/blocks connected in series) and a decoder 810 (which can include one or more decoder layers/blocks connected in series). Generally, the encoder 808 and the decoder 810 each include multiple neural network layers, at least one of which can be a self-attention layer. The parameters of the neural network layers can be referred to as the parameters of the language model.

The transformer 812 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 812 is trained to perform certain functions on input formats other than natural language input. For example, the input can include objects, images, audio content, video content, or a combination thereof.

The transformer 812 can be trained on a text corpus that is labeled (e.g., annotated to indicate verbs and nouns) or unlabeled. LLMs can be trained on a large unlabeled corpus. The term “language model,” as used herein, can include an ML-based language model (e.g., a language model that is implemented using a neural network or other ML architecture) unless stated otherwise. Some LLMs can be trained on a large multi-language, multi-domain corpus to enable the model to be versatile at a variety of language-based tasks, such as generative tasks (e.g., generating human-like natural language responses to natural language input).

FIG. 8 illustrates an example of how the transformer 812 can process textual input data. Input to a language model (whether transformer-based or otherwise) typically is in the form of natural language that can be parsed into tokens. The term “token” in the context of language models and NLP has a different meaning from the use of the same term in other contexts, such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list or a paragraph), an [EOT] token can be another special token that indicates the end of the textual sequence, other tokens can provide formatting information, etc.

In FIG. 8, a short sequence of tokens 802 corresponding to the input text is illustrated as input to the transformer 812. Tokenization of the text sequence into the tokens 802 can be performed by some pre-processing tokenization module such as, for example, a byte-pair encoding tokenizer (the “pre” referring to the tokenization occurring prior to the processing of the tokenized input by the LLM), which is not shown in FIG. 8 for brevity. In general, the token sequence that is inputted to the transformer 812 can be of any length up to a maximum length defined based on the dimensions of the transformer 812. Each token 802 in the token sequence is converted into an embedding vector 806 (also referred to as “embedding 806”).

An embedding 806 is a learned numerical representation (such as, for example, a vector) of a token that captures some semantic meaning of the text segment represented by the token 802. The embedding 806 represents the text segment corresponding to the token 802 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 806 corresponding to the “write” token will be closer to another embedding corresponding to the “jot down” token in the vector space as compared to the distance between the embedding 806 corresponding to the “write” token and another embedding corresponding to the “summary” token.

The vector space can be defined by the dimensions and values of the embedding vectors. Various techniques can be used to convert a token 802 to an embedding 806. For example, another trained ML model can be used to convert the token 802 into an embedding 806. In particular, another trained ML model can be used to convert the token 802 into an embedding 806 in a way that encodes additional information into the embedding 806 (e.g., a trained ML model can encode positional information about the position of the token 802 in the text sequence into the embedding 806). In some implementations, the numerical value of the token 802 can be used to look up the corresponding embedding in an embedding matrix 804, which can be learned during training of the transformer 812.

The generated embeddings 806 are input into the encoder 808. The encoder 808 serves to encode the embeddings 806 into feature vectors 814 that represent the latent features of the embeddings 806. The encoder 808 can encode positional information (i.e., information about the sequence of the input) in the feature vectors 814. The feature vectors 814 can have very high dimensionality (e.g., on the order of thousands or tens of thousands), with each element in a feature vector 814 corresponding to a respective feature. The numerical weight of each element in a feature vector 814 represents the importance of the corresponding feature. The space of all possible feature vectors 814 that can be generated by the encoder 808 can be referred to as a latent space or feature space.

Conceptually, the decoder 810 is designed to map the features represented by the feature vectors 814 into meaningful output, which can depend on the task that was assigned to the transformer 812. For example, if the transformer 812 is used for a translation task, the decoder 810 can map the feature vectors 814 into text output in a target language different from the language of the original tokens 802. Generally, in a generative language model, the decoder 810 serves to decode the feature vectors 814 into a sequence of tokens. The decoder 810 can generate output tokens 816 one by one. Each output token 816 can be fed back as input to the decoder 810 in order to generate the next output token 816. By feeding back the generated output and applying self-attention, the decoder 810 can generate a sequence of output tokens 816 that has sequential meaning (e.g., the resulting output text sequence is understandable as a sentence and obeys grammatical rules). The decoder 810 can generate output tokens 816 until a special [EOT] token (indicating the end of the text) is generated. The resulting sequence of output tokens 816 can then be converted to a text sequence in post-processing. For example, each output token 816 can be an integer number that corresponds to a vocabulary index. By looking up the text segment using the vocabulary index, the text segment corresponding to each output token 816 can be retrieved, the text segments can be concatenated together, and the final output text sequence can be obtained.

In some implementations, the input provided to the transformer 812 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user, and the output can include a high-level summary of the meeting notes. In other examples, the input provided to the transformer includes a question or a request to generate text. The output can include a response to the question, text associated with the request, or a list of ideas associated with the request. For example, the input can include the question, “What is the weather like in San Francisco?” and the output can include a description of the weather in San Francisco. As another example, the input can include a request to brainstorm names for a flower shop, and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an application programming interface. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### REMARKS

The terms “example,” “embodiment,” and “implementation” are used interchangeably. For example, references to “one example” or “an example” in the disclosure can be, but not necessarily are, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable medium comprising instructions that, when executed by one or more processors of a server system coupled to a short-form video hosting service, cause the system to perform a method for enhancing viewer engagement, the instructions causing the server system to:
cause display of, on a first portion of a user interface, a short-form video hosted on the short-form video hosting service,
wherein the short-form video is uploaded to the short-form video hosting service by a content provider having a content provider subscription to the short-form video hosting service, and
wherein the short-form video is viewable on the short-form video hosting service by multiple viewers who each have a viewer subscription to the short-form video hosting service;
receive, by a particular viewer of the multiple viewers, an input including a comment in response to the short-form video,
wherein the comment input includes a first text string;
cause display of, on a second portion of the user interface, the comment received from the particular viewer,
wherein the comment is configured for display on the second portion of the user interface in association with the short-form video, and
wherein the comment is viewable by the multiple viewers;
cause a generative artificial intelligence (AI) system to automatically create a response to the comment based on the first text string and metadata associated with the short-form video,
wherein the response created by the generative AI system includes a second text string different from the first text string; and
in response to approval from the content provider to publish the response created by the generative AI system, cause display of the response proximate to the comment on the second portion of the user interface.

2. The computer-readable medium of claim 1, wherein to cause the generative AI system to automatically create the response to the comment comprises causing the server system to:
create the response based on one or more graphical objects included in the comment, in addition to the first text string,
wherein the one or more graphical objects are configured to express an emotion, a reaction, and/or a concept in an electronic communication.

3. The computer-readable medium of claim 1, wherein to cause the generative AI system to automatically create the response to the comment comprises causing the server system to:
create the response based on input including multiple comments associated with the short-form video received from one or more viewers of the multiple viewers,
wherein the multiple comments are weighted less than the comment in creation of the response by the generative AI system.

4. The computer-readable medium of claim 1,
wherein the short-form video further includes audio content, and
wherein the response is further created by the generative AI system based on input including the audio content of the short-form video.

5. The computer-readable medium of claim 1,
wherein the response is further created by the generative AI system based on input including a viewer profile associated with the particular viewer that provided the comment.

6. The computer-readable medium of claim 1,
wherein the second text string of the response is configured in accordance with a style that is predefined or selected by the content provider.

7. The computer-readable medium of claim 1, wherein the server system is further caused to:
prior to receiving the approval from the content provider to publish the response,
cause display of, on an additional user interface, the response created by the AI system,
wherein the additional user interface is accessible by the content provider; and
display, on the additional user interface, an approval control item for receiving an input for the approval to publish the response.

8. The computer-readable medium of claim 1, wherein the server system is further caused to:
prior to receiving the approval from the content provider to publish the response,
display, on an additional user interface, the response created by the generative AI system;
receive an input from the content provider to modify the response created by the generative AI system; and
receive an approval from the content provider to publish the modified response,
wherein the response that is published to the comment on the second portion of the user interface corresponds to the modified response.

9. The computer-readable medium of claim 1,
wherein the short-form video is created by a user associated with the short-form video hosting service, and
wherein the user is different from the content provider.

10. The computer-readable medium of claim 1, wherein the server system is further caused to:
generate a description of the short-form video included in the metadata by processing the short-form video to extract closed captioning from audio associated with the video.

11. The computer-readable medium of claim 1, wherein the server system is further caused to:
receive a description of the short-form video included in the metadata from the content provider; and
store the description of the short-form video in the metadata associated with the short-form video.

12. The computer-readable medium of claim 1, wherein the server system is further caused to:
receive additional inputs corresponding to multiple comments associated with the short-form video;
display the multiple comments on the second portion of the user interface;
cause the AI system to create respective responses to the multiple comments; and
in response to receiving approvals from the content provider to publish the respective responses created by the AI system,
display the respective responses adjacent to the multiple comments on the second portion of the user interface.

13. The computer-readable medium of claim 12,
wherein the respective responses are published by causing display of the respective responses sequentially at a particular frequency on the second portion of the user interface.

14. The computer-readable medium of claim 12, wherein the server system is further caused to:
prior to receiving the approval from the content provider to publish the respective responses,
cause display of, on an additional user interface, the respective responses created by the AI system; and
cause display of, on the additional user interface, an approval control item for receiving an input for the approval to publish all the respective responses.

15. The computer-readable medium of claim 12,
wherein the respective responses include text and/or one or more images, and
wherein the respective responses are different from each other.

16. The computer-readable medium of claim 1, wherein the server system is further caused to:
prior to receiving the approval from the content provider to publish the response,
cause display of, on an additional user interface, the response created by the AI system,
wherein the response created by the AI system is based on a pre-trained large language model (LLM) algorithm;
receive an input from the content provider to modify the response created by the AI system; and
cause the AI system to further train the LLM algorithm based on the input to modify the response.

17. The computer-readable medium of claim 1,
wherein the response created by the generative AI system includes the second text string and one or more graphical objects configured for use in electronic communication to express an emotion, a reaction, and/or a concept.

18. The computer-readable medium of claim 1,
wherein the generative AI system is trained to create content that mimics a style, substance, or tone of the content provider.

19. A system for enhancing viewer engagement, the system comprising:
at least one hardware processor; and
at least one non-transitory memory storing instructions, which, when executed by the at least one hardware processor, cause the system to:
cause display of, on a first portion of a user interface, a short-form video hosted on a short-form video hosting service,
wherein the short-form video is uploaded to the short-form video hosting service by a content provider, and
wherein the short-form video is viewable on the short-form video hosting service by multiple viewers;
receive, by a particular viewer of the multiple viewers, an input including a comment in response to the short-form video,
wherein the comment input includes a first text string;
cause display of, on a second portion of the user interface, the comment received from the particular viewer;
cause a generative artificial intelligence (AI) system to automatically create a response to the comment based on the first text string and metadata associated with the short-form video,
wherein the response created by the generative AI system includes a second text string different from the first text string; and
in response to approval from the content provider to publish the response created by the generative AI system, cause display of the response proximate to the comment on the second portion of the user interface.

20. A method for enhancing viewer engagement, comprising:
causing display of, on a first portion of a user interface, a short-form video hosted on a short-form video hosting service,
wherein the short-form video is uploaded to the short-form video hosting service by a content provider, and
wherein the short-form video is viewable on the short-form video hosting service by multiple viewers;
receiving, by a particular viewer of the multiple viewers, an input including a comment in response to the short-form video,
wherein the comment input includes a first text string;
causing display of, on a second portion of the user interface, the comment received from the particular viewer;
causing a generative artificial intelligence (AI) system to automatically create a response to the comment based on the first text string and metadata associated with the short-form video,
wherein the response created by the generative AI system includes a second text string different from the first text string; and
in response to approval from the content provider to publish the response created by the generative AI system, causing display of the response proximate to the comment on the second portion of the user interface.
